(19) United States
(12) Patent Application Publication
(10) Pub. No.: US 2026/0154936 A1
(43) Pub. Date: Jun. 4, 2026

(54) IMAGE PROCESSING METHOD AND DEVICE

(71) Applicant: Lenovo (Beijing) Limited, Beijing (CN)

(72) Inventors: Xiang FENG, Beijing (CN); Koji KAWAKITA, Beijing (CN)

(21) Appl. No.: 19/403,663

(22) Filed: Nov. 28, 2025

(30) Foreign Application Priority Data
Nov. 29, 2024 (CN) 202411748393.4

(51) Int. Cl. G06V 10/70; G06T 7/11

(52) U.S. Cl. CPC G06V 10/70; G06T 7/11

(57) ABSTRACT

An image processing method includes: in response to a target trigger operation, performing recognition processing on a target image, where the target image is an image input to a target application or an image currently displayed by the target application, and the target application is an application capable of performing the recognition processing or calling a target program file to perform the recognition processing; and outputting a recognition result for the target image, where the recognition result is capable of indicating source information of at least a portion of an image content of the target image.

### CROSS-REFERENCE TO RELATED APPLICATION(S)

This application claims priority to Chinese Patent Application No. 2024117483934 filed on Nov. 29, 2024, which is incorporated herein by reference in its entirety.

### FIELD OF THE TECHNOLOGY

The present disclosure relates to an image processing method and device.

### BACKGROUND

Rapid development of the new generation of artificial intelligence technology, represented by generative artificial intelligence technology, has enabled people to easily generate high-quality images or edit and tamper with an authentic image, thereby producing deepfake images. These high-quality deepfake images are highly realistic, and it is usually difficult for people to tell with naked eye whether the target image is an authentic image or a deepfake image.

Deepfake technology and deepfake images may be used by criminals, which pose a huge threat to user safety. Taking video conferencing scenarios as an example, users cannot accurately distinguish the authenticity of the characters in images and videos, which makes users trust the other party easily, leading to adverse consequences such as property loss or even endangerment of life safety.

### SUMMARY

In one aspect, the present disclosure provides an image processing method. The method includes: in response to a target trigger operation, performing recognition processing on a target image, where the target image is an image input to a target application or an image currently displayed by the target application, and the target application is an application capable of performing the recognition processing or calling a target program file to perform the recognition processing; and outputting a recognition result for the target image, where the recognition result is capable of indicating source information of at least a portion of an image content of the target image.

In another aspect, the present disclosure provides an electronic device. The device includes: a memory storing computer program instructions; and a processor coupled to the memory and configured to execute the computer program instructions and perform: in response to a target trigger operation, performing recognition processing on a target image, where the target image is an image input to a target application or an image currently displayed by the target application, and the target application is an application capable of performing the recognition processing or calling a target program file to perform the recognition processing; and outputting a recognition result for the target image, where the recognition result is capable of indicating source information of at least a portion of an image content of the target image.

In yet another aspect, the present disclosure provides an electronic device with a non-transitory computer-readable storage medium storing computer program instructions executable by at least one processor to implement a processing model, the processing model being called upon by a target application to perform: in response to a target trigger operation, performing recognition processing on a target image, where the target image is an image input to a target application or an image currently displayed by the target application, and the target application is an application capable of performing the recognition processing or calling a target program file to perform the recognition processing; and outputting a recognition result for the target image, where the recognition result is capable of indicating source information of at least a portion of an image content of the target image.

### BRIEF DESCRIPTION OF THE DRAWINGS

FIG. 1 is a flowchart of an image processing method according to certain embodiments of the present disclosure;

FIG. 2 is a flowchart of S10 of an image processing method according to certain embodiments of the present disclosure;

FIG. 3 is a flowchart of S101 of an image processing method according to certain embodiments of the present disclosure;

FIG. 4 is a flowchart of S103 of an image processing method according to certain embodiments of the present disclosure;

FIG. 5 is a flowchart of S20 of an image processing method according to certain embodiments of the present disclosure;

FIG. 6 is a block diagram of an image processing device according to certain embodiments of the present disclosure;

FIG. 7 is a flowchart of an image processing method according to certain embodiments of the present disclosure;

FIG. 8 is a flowchart of an image processing method according to certain embodiments of the present disclosure;

FIG. 9 is a flowchart of obtaining image feature data according to certain embodiments of the present disclosure;

FIG. 10 is a flowchart of obtaining image classification according to certain embodiments of the present disclosure;

FIG. 11 is a flowchart of obtaining text feature data according to certain embodiments of the present disclosure;

FIG. 12 is a flowchart for obtaining text feature data according to certain embodiments of the present disclosure;

FIG. 13 is a flowchart for obtaining fused feature data according to certain embodiments of the present disclosure;

FIG. 14 is a flowchart for autoregressive decoding of fused feature data according to certain embodiments of the present disclosure;

FIG. 15 is a flowchart for a self-attention mechanism according to certain embodiments of the present disclosure;

FIG. 16 is a flowchart of a causal attention mechanism according to certain embodiments of the present disclosure;

FIG. 17 is a flowchart of a cross-attention mechanism according to certain embodiments of the present disclosure; and

FIG. 18 (a)-(c) are schematic diagrams of an image processing method according to certain embodiments of the present disclosure.

### DETAILED DESCRIPTION

Various aspects and features of the present disclosure are described herein with reference to the accompanying drawings.

Various modifications may be made to the embodiments described herein. Therefore, the description should not be construed as limiting, but merely as illustrative of certain embodiments. Other modifications within the scope and spirit of the present disclosure may occur to those skilled in the technical field.

The accompanying drawings, which are incorporated in and constitute a part of the present disclosure, illustrate certain embodiments of the present disclosure and, together with the description of the present disclosure given herein, serve to explain the principles of the present disclosure.

These and other features of the present disclosure will become apparent from the following description of certain embodiments, which are given as non-limiting examples with reference to the accompanying drawings.

Although the present disclosure has been described with reference to certain embodiments, those skilled in the technical field may readily recognize that many other equivalent forms of the present disclosure are possible.

The foregoing and other aspects, features, and advantages of the present disclosure will become more apparent from the following detailed description when taken in conjunction with the accompanying drawings.

Certain embodiments of the present disclosure will be described hereinafter with reference to the accompanying drawings; however, the embodiments described are merely examples of the present disclosure and may be implemented in a variety of ways. Familiar and/or repetitive functions and structures may not be described in detail to avoid obscuring the present disclosure with unnecessary or redundant details. Therefore, the structural and functional details described herein are not intended to be limiting, but rather serve merely as a basis and representative basis for the claims to teach those skilled in the technical field to utilize the present disclosure with any suitable detailed structure.

The present disclosure may use the phrases “in certain embodiments” to refer to one or more of the same or different embodiments of the present disclosure.

Effectively detecting and identifying deepfake images and attributing the target image and the technology used to generate them is crucial for ensuring user safety and safeguarding network security.

When determining whether a target image is an authentic image or a deepfake image, certain related technologies may determine the authenticity of the target image.

However, when users are presented with a target image, they often have more advanced, personalized needs beyond simply determining the overall authenticity of the target image. For example, they want to know the authenticity of a certain region within the target image and the reasons why the target image is judged to be authentic or a deepfake. They also want to ask personalized questions about the target image's authenticity and expect detailed, easy-to-understand answers. These requirements are difficult to meet with existing technical solutions.

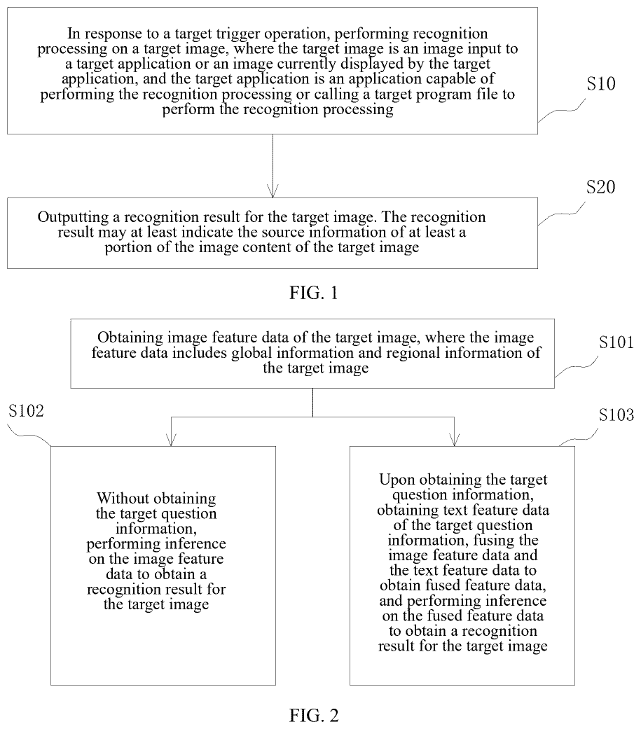

Therefore, an image processing method according to certain embodiments of the present disclosure, as shown in FIG. 1, includes:

S10. In response to a target trigger operation, performing recognition processing on a target image, where the target image is an image input to a target application or an image currently displayed by the target application, and the target application is an application capable of performing the recognition processing or calling a target program file to perform the recognition processing;

In certain embodiments, the target trigger operation refers to a user-performed action or system event that triggers subsequent processing. The target trigger operation includes, but is not limited to:

1) User input of a target image

For example, a user clicks the “Upload Picture” button on the interactive interface of the target application or a picture-sharing social platform (the platform uses the technical solution disclosed in the present disclosure, or the platform is an associated platform of the target application mentioned in the present disclosure, and the platform marks the source information of the displayed pictures, and therefore identifies the source information of the uploaded pictures), and then selects a picture from the mobile phone album and uploads it to the platform. This upload action may be regarded as a target trigger operation.

Alternatively, a user may use their phone's camera to take a photo of an item in a shopping application and then upload it directly to the application for identification. The act of taking the photo and uploading it triggers image recognition.

2) Question the target image

This questioning may take the form of voice or text. For example, a user might enter the text “Is this picture authentic?” into the search bar of an image recognition application. This text input constitutes a questioning action, triggering the target application to identify the animal in the uploaded image.

The target image refers to the image to be recognized, including images currently displayed by the target application and images input to the target application. The target image may be an image input by the user or an image currently displayed by an application. For example, a photo uploaded by a user to social media or an image displayed on a webpage.

3) Selection of question options on the application interface

Users initiate image-related processing or analysis by selecting question options on the application interface. The application provides one or more preset questions or question options related to image processing. These options are usually related to the application's image analysis, recognition, or search functions. Users tell the application the image processing task they want to perform by clicking, touching, or selecting these preset question options.

For example, a user opens an application and sees a list of options, including “Is this picture authentic?”, “What object is this?”, “Where is this scene?”, “What device was this picture taken on?”, and “Who took this picture?” The user selects “Is this picture authentic?”. After receiving the user's selection, the application triggers the image recognition function to analyze the uploaded image.

4) Image recognition operations based on scene changes or recognition triggers

This generally refers to automatically initiating an image recognition process upon a scene change or upon identifying a target scene. For example, an intelligent security monitoring system, which utilizes the technical solution of the present disclosure, automatically initiates image recognition when a surveillance camera detects a scene change, such as the sudden appearance of a face in a certain area. The system analyzes the captured image to determine whether it is fabricated, tampered with, or generated by an AI model (such as a GAN-generated fake image).

This recognition process may identify the source of the target image, such as the generative model or target camera, the terminal, or the location of the image.

The target image is an image input to a target application or the image currently displayed by the target application. The target application is an application capable of performing recognition processing or calling other program files to perform recognition processing. For example, a recognition software capable of identifying the source of an image may be used to identify the origin of an object in an image, such as whether the image is captured in the real world or generated from a model, or which camera, terminal, or location the image originated from.

In other words, the target image may be an image input to an image authenticity verification application for image authentication, or it may be used to directly authenticate the content displayed in the current application interface, such as images displayed in WeChat, a browser, or a website.

For example, a user receives an image on WeChat and wants to verify its authenticity. The user may save and upload the image to a dedicated image authenticity verification application (image source verification application) or simply long-press the image within the WeChat interface to trigger the image authenticity verification application (image source verification app) to authenticate the image. This application analyzes the image's ELA value to help the user determine whether the image has been tampered with.

The target application performing the identification process is an application with image source verification capabilities, such as image authenticity recognition and/or localized authenticity verification.

The target program file may be an application, a piece of program code, or a model file. The target application cannot directly verify the source or authenticity of an image, but may verify the authenticity of an image or trace its origin by calling an image authenticity verification application, code file, or model file.

S20. Outputting a recognition result for the target image. The recognition result may at least indicate the source information of at least a portion of the image content of the target image.

In certain embodiments, there is no restriction on the type of output format of the recognition result obtained after the recognition process and the output format may be text, image, or voice output.

The at least partial image content includes the foreground image, the background image, or a partial object in the foreground or background. For example, when a user uploads a photo of a park, the foreground image may be identified as a bench, the background image as a distant lake, and the partial object may be identified as a children's slide in the foreground or a boat in the background.

The source information refers to the origin of the target image, such as the generative model, camera, terminal, or location from which the image was generated. Furthermore, the source information may also include information such as the name, location, and time of at least part of the target image.

For example, the recognition result may be output as text, such as “The image is authentic,” “The foreground image is authentic and identified as a German Shepherd,” or “The image is fake, fabricated by the StyleGAN model.”

When using the present disclosure, a user clicks the “Upload Image” button in an image recognition application, selects a picture from their phone's photo album (either a user-taken picture or downloaded from the internet), and uploads it to the platform. This upload triggers the image recognition process.

The uploaded photo becomes the target image and is input into the image recognition application. The image recognition application receives the uploaded photo and prepares to perform recognition processing. The application is capable of performing recognition processing or may call on built-in program files (such as deep learning models) to assist in recognition.

The application begins analyzing the photo, using a deep learning model to identify the foreground image (for example, a bench, a children's slide), the background image (for example, a lake, a boat), and the image's source information (for example, camera model, location, and time of capture). After analysis, the application displays the following text: “Foreground image is fake, foreground image generated by a StyleGAN model, background image is authentic.”

The present disclosure may more accurately identify the authenticity and source information of at least part of an image's content, providing users with richer and more convincing recognition results, improving recognition reliability and interactivity.

In certain embodiments, performing recognition processing on a target image in response to a target trigger operation includes one or more of:

1) Recognizing the target image in response to a target user inputting the target image into a target application.

In certain embodiments, the user performs an action of inputting image data into the target application. The target application receives the image data input by the user and processes the received image data to identify content or features within the image. The user inputting the target image into the target application involves the user uploading the image to be recognized.

For example, consider an image recognition application that may identify the authenticity of an image, the model, device, or photographer, and so on. A user opens the application and clicks the “Select Image” button on the application interface. The user selects a garden photo from their phone's photo album and uploads it to the application. Upon receiving the uploaded photo, the application automatically analyzes it. Using the technical solution of the present disclosure, the photo is identified as authentic.

2) In response to obtaining target question information for a target image displayed by a target application, recognition processing corresponding to the target question information is performed on the target image.

In certain embodiments, the target image may be the image currently displayed by the target application, or a particular image, such as an image sent by a particular person, or a particular related image (for example, an image of the Great Wall, a photo of a famous person).

The currently displayed image may be automatically loaded by the application or the result of a user's previous browsing or operation. For example, a user is using a news reading application and reading an article about natural scenery. The article contains an image of a waterfall. This image of the waterfall is the image currently displayed by the target application and may be used as the target image for recognition processing, such as verifying the authenticity of the image and identifying the model, device, or photographer of the image.

For example, a user receives a photo of their pet dog from a friend via WeChat and asks whether the dog's fur color is authentic. This photo of the pet dog is an image sent by a particular person and may be used as a target image for recognition processing to determine whether a portion of the image (the fur color) is fabricated and generated by the StyleGAN model.

Or, a user interested in the history of the Great Wall enters the keyword “Great Wall” into a search engine, and the search results display multiple images of the Great Wall. These images of the Great Wall are particular and relevant and may be used as target images for recognition processing, such as identifying the model, device, or photographer from which the image originated.

The target question information includes questions about the image's source and authenticity. Users may ask about the image's origin, such as who took the image, where it was taken, when it was taken, and what equipment was used. Users may also question the image's authenticity, wanting to confirm whether it has been tampered with or edited, and whether it is the original, unaltered version.

For example, a user may see a compelling news photo on social media and want to verify the image's source. They might ask, “When and where was this photo taken?”

Or, a user might see a photo of a politician on a news website and suspect it may have been manipulated to influence public opinion. The user might ask, “Is this image original?” or “Has this image been photoshopped?”

The recognition process corresponding to the target question information may be a default recognition process or a question-specific recognition process. The default recognition process means that regardless of the user's question, the system will perform a preset recognition process. For example, the system might default to performing image authenticity verification on all uploaded images.

In certain embodiments, an image processing application's default setting is to authenticate all uploaded images. Regardless of the question a user asks after uploading an image, the application first authenticates the image to check for tampering or editing. For example, when a user uploads a landscape photo and asks, “Where was this photo taken?” Even though the user's question has nothing to do with the image's authenticity, the application will still authenticate it before attempting to answer the user's question.

Question-specific recognition processing involves the system selecting the appropriate recognition processing flow based on the user's question. When the user's question concerns a particular aspect of the image, the system will perform recognition processing related to that aspect.

For example, when a user uploads the same celebrity photo and asks, “When was this photo taken?” the application will recognize this as a question about when the image was taken and will perform various recognition processes, such as reading image metadata or using image content analysis techniques to estimate the time of capture.

3) In response to a selection operation for a question option displayed by the target application for a target image, recognition processing corresponding to the selection operation is performed on the target image.

In certain embodiments, the user is provided with preset question options. The application provides a series of preset question options that cover different recognition requirements, such as image authenticity, building identification, and location identification. The user selects one or more questions from these preset options based on their query requirements for the target image. In response to the user's selection, the application performs recognition processing on the target image corresponding to the selected question.

The recognition processing corresponding to the selected operation includes, but is not limited to, image authenticity recognition, building identification, location identification, device identification, and camera type identification.

For example, an application using the technical solution of the present disclosure provides a series of preset question options for users to choose from to identify and answer questions about images. Preset question options include: “Image Authenticity Verification,” “Building Identification,” “Location Identification,” “Camera Equipment Identification,” and “Lens Type Identification.”

A user sees a photo of a cityscape in an application and wants to know where it was taken. The user selects “Location Identification” from a preset question. In response to the user's selection of “Location Identification,” the application begins with geotagging the target image, potentially using image recognition technology, Geographic Information System (GIS) data, and online databases to determine the photo's location. After the analysis is complete, the application displays the identification result: “This photo was taken near the Eiffel Tower in Paris.”

4) In response to obtaining the target user's input of the target image into the target application and the target question information regarding the target image, the application performs recognition processing on the target image corresponding to the target question information.

In certain embodiments, a user inputs an image into a target application. This operation may be uploading, taking a photo, or selecting an image. The user then asks questions about the input image, such as questions about the image's content, source, authenticity, or the like. Based on the user's operation and question, the system performs corresponding recognition processing on the target image to answer the user's question. In other words, the user inputs the image to be recognized as well as the question.

For example, a user using an application that employs the technical solution of the present disclosure uploads a photo of an ancient statue taken in a museum and asks, “Is this statue authentic?” The application responds to the user's question and uses the image processing method of the present disclosure to determine the statue's authenticity.

5) In response to detecting a change in usage information of the electronic device, performing recognition processing on the target image displayed by the target application.

In certain embodiments, the usage information may represent a trigger operation that triggers the recognition processing. The change in usage information may include a change in the usage scenario or the user. For example, the usage information may include the device's state, environment, or user operation. When such information changes, the system automatically performs image processing to recognize and analyze the currently displayed image.

For example, a smart home security system equipped with cameras to monitor a home. The system may detect changes in the scene and automatically initiate image recognition when it detects particular events.

When the camera detects someone approaching your home, this is a scene change because the area previously monitored by the camera was empty. The camera automatically captures this scene and initiates the image recognition process.

In certain embodiments, as shown in FIG. 2, performing recognition processing on a target image includes:

S101: Obtaining image feature data of the target image, where the image feature data includes global information and regional information of the target image.

In certain embodiments, global information refers to the overall characteristics of the image, such as global features such as color distribution, texture, and shape. Regional information refers to the characteristics of particular areas or objects in the image, such as detailed features such as edges, corners, and local textures of particular objects.

For example, the target image is a photograph of a natural landscape containing flowers. Global information may include the image's overall color tendency (for example, predominance of green and red) and overall texture (for example, the texture of the grass and the texture of the flowers). Regional information may include the flower's edge contours, the local texture of the petals, and the detailed features of the stamens.

S102: Without obtaining the target question information, performing inference on the image feature data to obtain a recognition result for the target image.

In certain embodiments, given only the target image as input, the classification model is directly used for inference, inferring the image's content based on the extracted image feature data and generating a recognition result. For example, continuing with the flower photo example above, without a particular question, the system may use a pre-trained classification model to determine the image's authenticity and output the recognition result: “The image is fabricated.” Alternatively, the system might output, according to the pre-trained classification model's preset recognition result output parameters, whether the target image is a photographic image or generated using a generative model.

In certain embodiments, an autoregressive decoding model may be used to output source information and the corresponding reasoning.

S103: Upon obtaining the target question information, obtaining text feature data of the target question information, fusing the image feature data and the text feature data to obtain fused feature data, and performing inference on the fused feature data to obtain a recognition result for the target image.

In certain embodiments, as shown in FIG. 8, when the user simultaneously inputs the target image and question information, image feature data is obtained through image encoding, and text feature data is obtained through word embedding representation and word embedding encoding modules.

The image and text feature data are processed through the image-text feature fusion module to generate fused features. This module associates the semantic information in the text question with the overall and key regional information of the target image to support text questions about the target image as a whole and in its locale.

The autoregressive decoding module performs inference based on the fused feature data, generating a text statement that corresponds to the image category judgment and outputting a text answer.

In certain embodiments, the question information may include speech-to-text processing, image-to-text processing, or semantic recognition to obtain text input.

For example, a user uploads a photo of multiple flowers and asks, “Is this red flower authentic?” The system first extracts the text features of the question and then fuses them with regional image information (such as the red flower). Through this fusion process, the system may more accurately identify the source information of the red flower and answer the user's question: “This red flower is authentic” or “This red flower is from Lenovo's Creator zone.”

The present disclosure may handle scenarios where only images are present (direct inference via a classification model) as well as scenarios where both images and text question information are present (inference via the fusion of image and text feature data). This flexibility enables the system to more comprehensively understand and respond to user needs.

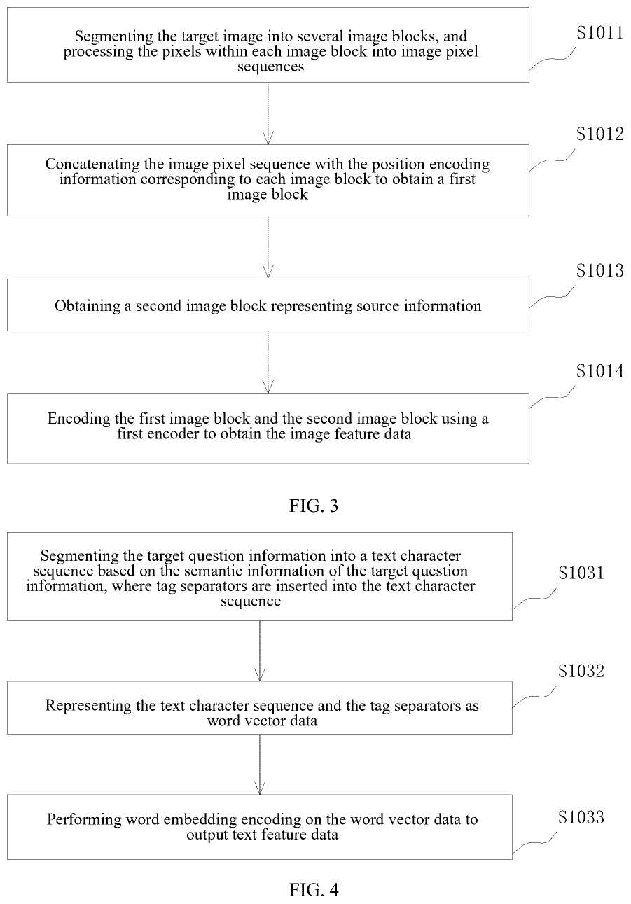

In certain embodiments, as shown in FIG. 3, obtaining image feature data for the target image includes:

S1011. Segmenting the target image into several image blocks, and processing the pixels within each image block into image pixel sequences.

In certain embodiments, the entire image is segmented into nine small blocks, each of which is referred to as an image block. The pixels within each image block are then processed into a sequence, for example, an image pixel sequence. This provides more fine-grained data for subsequent feature extraction and analysis.

S1012. Concatenating the image pixel sequence with the position encoding information corresponding to each image block to obtain a first image block.

In certain embodiments, the image pixel sequence of each image block is combined with its corresponding position encoding information (for example, the position of the image block in the original image) to form a new data structure, referred to as the first image block. The position encoding information helps maintain the spatial relationship between the image blocks during subsequent processing.

S1013. Obtaining a second image block representing source information.

In certain embodiments, a learnable category embedding is used to represent the image classification task. The category embedding is concatenated with index 0 to generate an embedding image block representing the category information.

Category embedding is a technique that converts discrete category labels into continuous vectors. In image classification tasks, this means mapping each category (such as a different object or scene) to a point in a high-dimensional space that captures the characteristics of the category. By concatenating the category embedding with the index 0, one may create an embedding image block representing the category information, which may be used to train a model to recognize categories in an image.

S1014. Encoding the first image block and the second image block using a first encoder to obtain the image feature data.

In certain embodiments, a first encoder is used to encode the first image block (including the pixel sequence and position encoding information of the image block) and the second image block (including the source information). This process extracts image feature data, which may be used for subsequent image recognition, classification, or other analysis tasks.

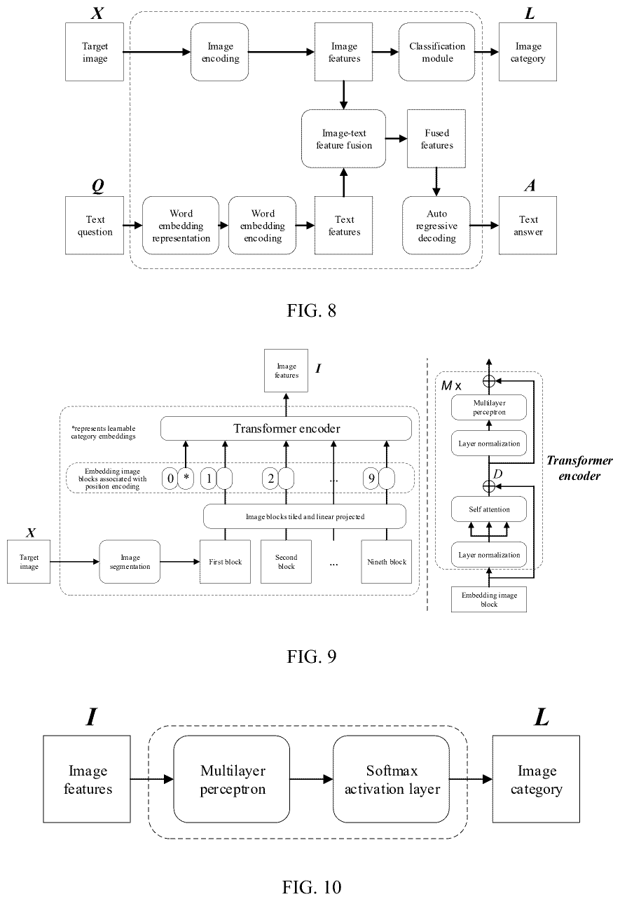

In certain embodiments, the present disclosure obtains image feature data through image coding. As shown in FIG. 9, the target image X generates image feature I through the image coding module. The target image X is evenly divided into N image blocks, each image block corresponds to a position index number, and all pixel points in each image block are tiled and linearly projected to generate a corresponding image pixel sequence. The position index number of each image block is position-coded to generate position coding information. The image pixel sequence and the position coding information are concatenated to form an embedding image block containing position information.

In order to introduce image category information into the image encoding process, a learnable category embedding is used to represent the image classification task. The category embedding is concatenated with the index number 0 to generate an embedding image block representing the category information.

In certain embodiments, the target image is first divided into 9 image blocks. The RGB values of all pixels in each image block are tiled and stacked to form a vector. Each vector has a length of L. The vectors of all N image blocks are combined to form a matrix with N rows and L columns. This matrix is transformed by linear projection to produce a new matrix with N rows but D columns. The value of D is usually smaller than L. In the new matrix, each image block corresponds to a numerical vector of length D. During the “embedding image block and position encoding” stage, the position indexes 0, 1, 2, . . . , N are each encoded as a position vector of length D. The position vectors corresponding to the numbers 1, 2, . . . , N are added to the numerical vectors of the corresponding image blocks to generate a “position embedding image block” vector, which combines image information and position information.

During the network model training stage, the category of the target image is encoded to generate a “category embedding” vector of length D. The “category embedding” vector is added to the position vector corresponding to sequence number 0 to generate a “category embedding image block” vector. The “position embedding image block” vector and the “category embedding image block” vector both belong to the “embedding image block” vector.

The embedding image block containing position information (the first image block) and the embedding image block representing category information (the second image block) are combined as embedding image blocks. The embedding image blocks are then passed through the Transformer encoder to generate image features I.

In certain embodiments, all the “embedding image block” vectors are combined to form a numerical matrix, which is then passed through the Transformer encoder to generate image features.

In certain embodiments, the Transformer encoder includes M Transformer modules stacked in sequence. When the value of M is 12, 24, or 32, the image encoding effect is best, and the output data of the previous Transformer module serves as the input data of the next Transformer module.

In each Transformer module, the input data is first normalized by the layer, and then passes through the self-attention module. The generated data is added to the input data to generate the intermediate feature D. The intermediate feature D is then normalized by the layer and multi-layer perceptron, and then added to the intermediate feature D to generate the output data of the current Transformer module. The image feature I generated by the last Transformer module serves as the output of the Transformer encoder and also as the output of the image encoding module.

In certain embodiments, before the embedding image blocks are input into the Transformer encoder, the data of all embedding image blocks are combined to form a numerical matrix. Each row of the numerical matrix corresponds to a vector of an embedding image block. The numerical matrix is input as a whole into the Transformer encoder for encoding processing.

The computational processes of the “layer normalization,” “self-attention,” and “multi-layer perceptron” modules in the Transformer encoder associate the data in different rows of the numerical matrix. Therefore, after processing by the Transformer encoder, the data of different embedding image blocks are fused, that is, the image information of different blocks is associated, so that the image features finally extracted may reflect the global context information of the image.

In certain embodiments, performing inference on the image feature data to obtain a recognition result for the target image includes one or more of:

1) inputting the image features into a classification model composed of a multilayer perceptron and a first activation function to obtain source information of at least a portion of the image content of the target image;

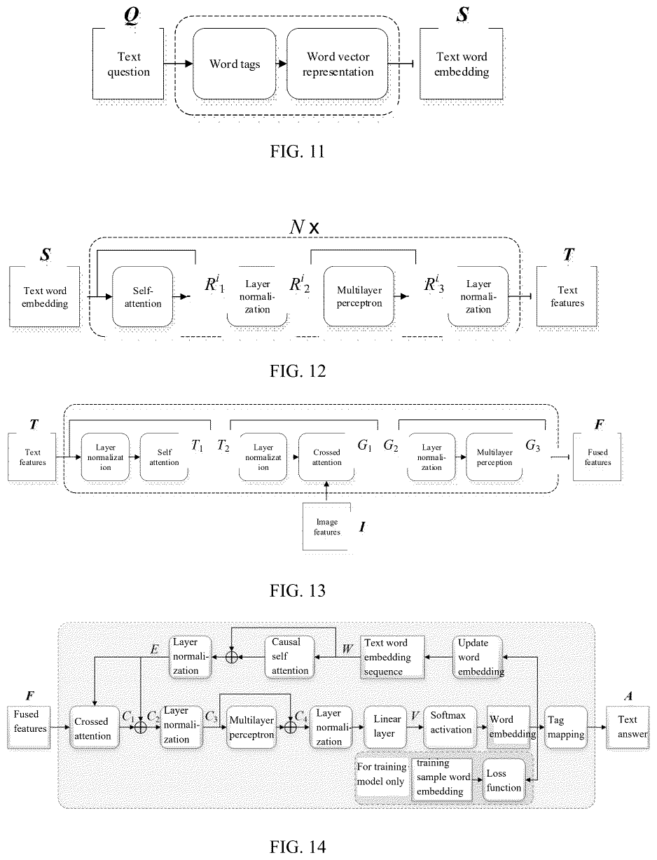

In certain embodiments, as shown in FIG. 10, a multilayer perceptron is a feedforward neural network composed of multiple layers, each containing multiple neurons. These neurons may learn complex patterns and relationships in the input data. The first activation function is the Softmax function.

The Softmax function is used in the output layer of the multilayer perceptron. The Softmax function converts the raw scores (also known as logits) output by the neural network into a probability distribution, such that the output value for each category is between 0 and 1, and the sum of the output values for all categories is 1. In this way, each output value may be interpreted as the model's prediction of the probability that the input image belongs to a certain category.

For example, consider an image recognition task where the goal is to identify whether the scene in an image is indoors or outdoors. First, features are extracted from the image, and then a multilayer perceptron model with two hidden layers is used to process these features. The output dimension of the last fully connected layer of the model is equal to the number of categories (in this case, 2, for example, indoors and outdoors). At the output layer, a Softmax activation function is applied to obtain the probability of each category. For example, when the output of the Softmax layer is [0.4, 0.6], this means that the model predicts that the probability of the image being indoors is 40% and the probability of being outdoors is 60%.

In certain embodiments, to identify whether an image is generated by AI (such as MidJourney) or authentic, features are first extracted from the image, including but not limited to: color features: AI-generated images may exhibit some unnatural color combinations, or relatively consistent color distribution in different areas; texture features: the generated image may lack the complexity of certain details, particularly on edges or small objects (such as details of people, hair, eyes, or the like may appear abnormal); regional inconsistency: AI-generated images may exhibit unnatural symmetry, artifacts or unrealistic details in certain regional areas (such as backgrounds or distant views).

These features are then processed using a multilayer perceptron model with two hidden layers. The output dimension of the model's final fully connected layer is equal to the number of categories (in this case, 2, for example, “authentic” vs. “AI-generated”). At the output layer, a Softmax activation function is applied to obtain the probability of each category.

The multi-layer perceptron (MLP) model used to process these features includes: Input layer: Extracted image features, such as color distribution and texture information, are used as input; Hidden layer: Contains two hidden layers, with the number of neurons in each layer designed based on the complexity of the task. Each layer performs nonlinear transformations on the features to extract higher-level image features. Output layer: The output dimension of the model's last fully connected layer is 2, corresponding to two categories: “authentic” and “AI-generated.” Category 0: Indicates that the image is “authentic”; Category 1: Indicates that the image is “AI-generated.”

At the output layer, a Softmax activation function is applied to obtain the probability for each class. The Softmax function converts the model output into a probability distribution for each class. For example, when the model output is [0.3, 0.7], this means the model predicts a 30% probability that the image is “authentic” and a 70% probability that it is “AI-generated.”

The output dimension may also be set to 4, corresponding to four classes: “Authentic,” “MidJourney Model,” “Stable Diffusion Model,” and “StyleGAN Model.” This not only confirms the authenticity of the image but also identifies the particular model that generated it.

2) Inputting the image features into a multilayer perceptron and an output layer formed with a second activation function to obtain source information of at least a portion of the image content of the target image and an explanation of the source information.

In certain embodiments, the multilayer perceptron is a neural network composed of multiple fully connected layers (also called dense layers), each containing multiple neurons, capable of learning the complex mapping relationship between image features and category labels. At the top of the multilayer perceptron, an output layer is formed using a second activation function, which is a Softmax function.

The model not only outputs the target image's category label (for example, source information) but also provides an explanation—the rationale for that conclusion. This is typically achieved through additional network structures or algorithms that explain the model's predictions.

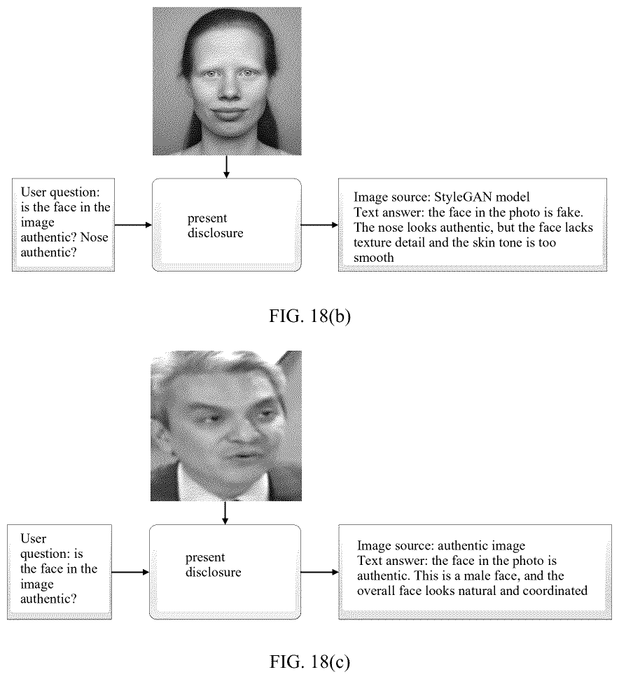

In certain embodiments, as shown in FIG. 18(b), an image is analyzed to determine whether a particular portion of it is authentic, along with a detailed explanation of the authenticity of the local region. The target image features a long-haired woman's face in the foreground, with a gray background. The user posed two questions regarding the image's authenticity: 1) the authenticity of the entire face, and 2) the authenticity of a local region of the face (for example, the nose).

When processing an image, key features are first extracted. These features may include texture features (such as skin texture and details), shape features (such as facial contours and structure), and color features (such as skin color, shading, and lighting). These features help determine whether the objects in the image are natural and conform to real world laws of physics.

The extracted features are then fed into a multi-layer perceptron model to determine whether the image was generated by a generative adversarial network (GAN) model like StyleGAN or originated from the real world.

The multilayer perceptron model includes two hidden layers, each using a ReLU activation function for nonlinear transformations to improve the model's expressive power. At the output layer, the model uses a Softmax activation function to determine the probability of an image being authentic or AI-generated (StyleGAN). For example, when the model output is [0.2, 0.8], this means the model has an 80% probability of judging the image as AI-generated (StyleGAN) and a 20% probability of judging it as authentic.

In addition to making a global judgment of authenticity, the model also employs an attention mechanism to identify key regions within the image that influence the decision. For example, in this image of a face, the attention mechanism highlights regions that influence the authenticity of the nose.

When the model determines that a face was generated by StyleGAN, it will further analyze and provide a detailed explanation of the nose area. For example, the model may detect that the nose appears natural, but the lack of details (such as skin texture, pores, blemishes, or the like) and the overly smooth skin tone indicate that the face is generated rather than authentic.

The text answer generated by the model provides a detailed explanation of the user's question. For example, in response to the question “Is the face in the photo authentic?” the model will answer: “The face in the photo is fake,” and further explain: “The nose looks authentic, but the face lacks texture details and the skin tone is overly smooth.”

In response to the question “Is the nose authentic?”, the model provides details through explanations: “The shape and appearance of the nose appear natural, but the overall lack of detail suggests it may be AI-generated.”

The entire image processing process involves not only a global judgment of the image's authenticity but also detailed explanations of local regions within the image to enhance the model's transparency and credibility. By incorporating techniques such as the attention mechanism, the model may provide targeted explanations, helping users understand why the model made a certain prediction. This allows for more informed decision support, particularly when processing complex image generation techniques (such as those generated by StyleGAN).

In certain embodiments, as shown in FIG. 4, extracting text feature data from the target question information includes:

S1031. Segmenting the target question information into a text character sequence based on the semantic information of the target question information, where tag separators are inserted into the text character sequence.

In certain embodiments, the user's natural language question is decomposed into a series of text characters, and tag separators (such as spaces, symbols, or the like) are inserted into these character sequences to help the model understand word and sentence structure.

For example, a user asks, “Is this picture authentic?” The system segments the question into a character sequence: “Is this picture authentic?” and inserts spaces between each character as tag separators.

S1032: Representing the text character sequence and the tag separators as word vector data.

In certain embodiments, a word vector maps each word or character in a text to a vector in a high-dimensional space. These vectors may capture the semantic information of the word or character. For example, the system converts each word and space into a corresponding word vector. For example, each word in “this,” “a piece,” or “picture” corresponds to a word vector. Spaces may also correspond to a word vector to represent the separation between words.

S1033. Performing word embedding encoding on the word vector data to output text feature data.

In certain embodiments, word embedding technology (such as Word2Vec, GloVe, or BERT) is typically used to encode the word vector data. This process generates text feature data, which may be used to represent the semantic information of the original text and be used in subsequent machine learning tasks.

When obtaining text feature data, as shown in FIG. 8, the present disclosure processes the text question Q through a word embedding representation module, which segments the text sentence into a sequence of text characters and inserts characters such as separators into the text character sequence. Each character is then processed through a word embedding encoding module to generate a corresponding word embedding vector. The word embedding vectors for all characters are combined to form the text feature data for the text question.

In certain embodiment, as shown in FIG. 11, the input data for the word embedding representation module is the text question Q, and the output data is the word embedding S of the text. The word embedding representation module includes two steps: word tagging and word vector representation.

During the word tagging phase, the text question Q is segmented into a sequence of text characters based on semantic information. Tag separators are inserted at the beginning and end of the text question, as well as at semantic segmentation locations.

In the word vector representation phase, all text characters and tag separators in the text character sequence are represented as numerical word vectors. Each text character and tag separator corresponds to a word vector, and all word vectors are stacked to form the text's word embedding S.

As shown in FIG. 12, the word embedding encoding module encodes the word embeddings S of a text into text features T. The word embedding encoding module includes N sequentially connected encoding layers, with the output data of each encoding layer becoming the input data of the next encoding layer.

In the i^{th} (1≤i≤N) encoding layer, the input data of this encoding layer passes through the self-attention module and is then added to the input data of this encoding layer to produce feature data Rⁱ1. Feature data Rⁱ1 undergoes layer normalization to produce feature data Rⁱ2.

After being processed through a multi-layer perceptron, feature data Rⁱ2 is added to feature data Rⁱ2 to generate feature data Rⁱ3. Feature data Rⁱ3 undergoes layer normalization to produce the output data of the i^{th} encoding layer. The output data of the final encoding layer serves as the output of the word embedding encoding module, namely, text features T.

For example, the system uses a pre-trained BERT model to encode the above word vectors. The BERT model considers the context of each word and outputs context-sensitive word embeddings for each word. These embeddings capture the complex relationships between words and may be used as text feature data to answer user questions, such as determining the color of an image.

The present disclosure may convert a user's natural language questions into machine-understandable text feature data. This data may be combined with image feature data to answer the user's questions about the image. This approach enables the model to process and understand complex natural language input and provide more accurate answers in multimodal learning tasks.

In certain embodiments, performing inference on the fused feature data to obtain a recognition result for the target image includes:

The fused feature data is decoded using an autoregressive decoding module to obtain response information for a question related to at least a portion of the image content of the target image.

In certain embodiments, fused feature data generally refers to data that combines image features and text features (for example, question features). This feature data may represent semantic information about the image content and the associated question.

The autoregressive decoding module is used in natural language processing and image processing, particularly in multimodal learning scenarios such as visual question answering (VQA).

The autoregressive decoding module uses an autoregressive model (such as a Transformer-based model) to gradually generate a response. At each step, the model predicts the next word or phrase based on the currently generated response and fused feature data. Ultimately, the response generated by the autoregressive decoding module answers the question about at least part of the target image and may include explanations of the source information.

In certain embodiments, the autoregressive decoding module performs inference based on the fused feature data, generating a text judgement corresponding to the image category judgment, and outputting a text answer.

For example, in an image question-answering system, a user uploads an image and asks, “How many birds are there in this image?”

The system first extracts the image's visual features and converts the user's question into text features. These features are then fused into a unified data representation for the subsequent decoding process.

The autoregressive decoding module begins, using the fused feature data to gradually construct the answer. At each step, the model considers the generated response (for example, “two”) and the fused feature data to predict the next word (for example, “bird”).

Finally, the decoding module generates a complete response: “There are two birds in this image.” This response not only answers the question but also potentially provides an explanation, such as “The answer is based on the morphological and numerical characteristics of the birds detected in the image.”

The present disclosure utilizes the fused feature data through the autoregressive decoding module to generate accurate responses and responses with explanations, enhancing the interactivity and transparency of the system.

In certain embodiments, the autoregressive decoding module decodes the fused feature data, by:

Decoding the fused feature data using a first decoder to obtain a first predicted text character, where the first decoder updates a word embedding sequence based on the first predicted text character;

In certain embodiments, the first decoder decodes the fused feature data (data that combines image features and question text features) to generate a first predicted text character. This predicted text character forms the beginning of the response information.

The first decoder updates its internal word embedding sequence based on the generated first predicted text character. This means that the decoder's internal state is adjusted based on the newly generated character to better predict the next character.

The updated first decoder decodes the fused feature data and the first predicted text character to generate a second predicted text character.

In certain embodiments, the updated first decoder again decodes the fused feature data and the newly added first predicted text character to generate a second predicted text character.

This process continues, with the decoder continuously generating new predicted text characters and updating its internal state until a terminator is generated.

When the second predicted text character is determined to be a terminator, response information is generated, where the response information includes the first predicted text character and the second predicted text character.

In certain embodiments, once the second predicted text character is determined to be a terminator, the decoding process ceases, and the response information includes all previously generated first and second predicted text characters.

In certain embodiments, as shown in FIG. 14, the autoregressive decoding module takes as input the fused features F and outputs the text answer A. This module uses an autoregressive approach to predict and output text characters one by one. The process of predicting the next text character depends not only on the input fused features but also on the previously predicted and output text characters.

After outputting a new text character, the autoregressive decoding module updates the word embeddings, generating a new text word embedding sequence W. This word embedding sequence W undergoes causal self-attention, a residual connection layer, and layer normalization to generate text features E corresponding to the previously output text answer. The input fused features F and text features E undergo cross-attention to produce feature C1.

During the cross-attention process, text features E are flattened to form the query vector, and fused features F are flattened to form the key vectors and value vectors.

Feature C1 is added to text features E to produce feature C2. Feature C2 undergoes layer normalization to produce feature C3. Feature C3 passes through a multi-layer perceptron and is then added to feature C3 to produce feature C4. Feature C4 undergoes layer normalization and a linear layer to produce feature vector V. Feature vector V is predicted through a Softmax activation layer to produce a word embedding. The word embedding is generated through tag mapping to the current text character, which is placed at the end of the current text answer.

The generated word embeddings are updated to generate a new word embedding sequence. This autoregressive process repeats until the text character generated by the tag mapping is the terminator. This generates the text answer A, which serves as the output of the autoregressive decoding module.

For example, a user uploads a picture and asks, “What is the person in this picture doing?”

The system first uses the first decoder to decode the fused feature data and generate the first predicted text character: “read.” The first decoder updates its internal word embedding sequence based on “read” and prepares to generate the next character.

The updated first decoder decodes the fused feature data and the word “read” again, generating the second predicted text character: “book.” This process continues, with the decoder generating subsequent characters, such as “.”, until it encounters the terminator.

When the decoder generates the terminator “.”, the decoding process stops. The response is now “read a book.”, the answer to the user's question.

Through this approach, the system may gradually construct a complete response, ensuring that each prediction is based on the latest contextual information. This iterative decoding process enables the model to generate coherent and relevant answers, improving the accuracy and naturalness of the responses.

In certain embodiments, outputting the recognition result for the target image includes one or more of:

1) outputting source information for at least a portion of the image content of the target image and an explanation of the source information;

In certain embodiments, the source information of the image content and the relevant reasons/basis are directly output. The explanation of the source information serves as the rationale for the conclusion. Source information refers to recognizable content in the image, such as object category, scene description, and action type.

For the recognized image content, the system also provides an explanation of why the model reached that recognition result, typically based on visual cues and contextual information in the image.

For example, the system identifies the Eiffel Tower as key information and determines that the image was taken in Paris. The system provides an explanation: “The Eiffel Tower in the image is a landmark building in Paris, so it may be inferred that the image was taken in Paris.”

2) Outputting source information for at least a portion of the image content of the target image and a first control, where the first control may be triggered to display an explanation of the source information;

In certain embodiments, instead of displaying the explanation directly, a control or a thumbnail display control (such as “View More”) is provided. When the control is triggered, the full explanation is displayed.

The first control is a user interface control provided by the system, such as a “View More” button or link, which the user may click to trigger the display of further explanations. When the user triggers the first control, the system displays a detailed explanation of the source information, explaining why the system reached the recognition result.

For example, a user uploaded a photo of the Eiffel Tower and asked, “Where was this image taken?”

The system identified the Eiffel Tower in the image and determined that the photo was taken in Paris. The system displayed a button in the user interface that read, “See location explanation.” After the user clicked “See location explanation,” the system displayed a detailed explanation: “The Eiffel Tower in the image is a landmark building in Paris. Based on its unique structural features and the other landmarks in the background, we determined that this image was taken in Paris.”

3) Outputting source information for at least a portion of the target image's image content, and, when the source information is triggered, outputting an explanation of the source information.

In certain embodiments, the source information is not displayed directly on the interface, but rather in the form of a control (such as a button or link). Users may use this control to trigger further operations.

When the user further clicks on the source information, an explanation is triggered. In certain embodiments, when the user interacts with the control (for example, clicking a button), the system displays a detailed explanation of the source information. This explanation provides the rationale behind the source information.

For example, a user uploads a photo of the Eiffel Tower and asks, “Where was this photo taken?”

After analyzing the image, the system determines that the photo was taken in Paris and displays a button on the interface that reads “Show Location Information.” The source information (Paris) isn't displayed directly on the interface; it's triggered by clicking the “Show Location Information” button.

After the user clicks the “Show Location Information” button, the system displays a pop-up window or sidebar with a detailed explanation: “The Eiffel Tower in the image is a landmark building in Paris. Based on its unique structural features and the other landmarks in the background, we have determined that this image was taken in Paris.”

4) Outputting source information for at least a portion of the target image's image content and a first response to the first question regarding the at least a portion of the image content.

In certain embodiments, the source information for at least a portion of the image content includes the category of objects in the image, a description of the scene, the context of the event, and the like.

In addition to displaying source information, other responses to questions may also be displayed. The first question is a question posed by the user regarding at least part of the image content. The first response is a targeted answer provided by the system based on the user's question and the image content.

When the user's question is not about the authenticity of the image, but rather the image's creation or acquisition time, the corresponding response information may include a timestamp or other information, such as the photographer or location.

5) Outputting source information for at least a portion of the target image's image content and a second control, where the second control may be triggered to display information related to the source information.

In certain embodiments, the system provides a user interface control (second control), such as a “More Information” button or link. This control is designed as a recommendation control for the source information, triggering the display of more content related to the source information.

When the user interacts with the secondary control (for example, clicking a button), the system displays recommended information related to the source information. This information may include purchase links, configuration interfaces, sharing interfaces, and more.

For example, a user uploads a photo of the Eiffel Tower in Paris and asks, “What is the background of this image?”

After analyzing the image, the system determines that the background is Paris and displays a button labeled “Explore Paris.” The user may click this button to learn more about Paris.

After the user clicks the “Explore Paris” button, the system displays a pop-up window or sidebar containing the following recommendations: a purchase link for a model of the Eiffel Tower; a travel destination configuration interface that allows the user to set Paris as a travel destination and displays travel package information; and a sharing interface that provides the option to share the image on social media.

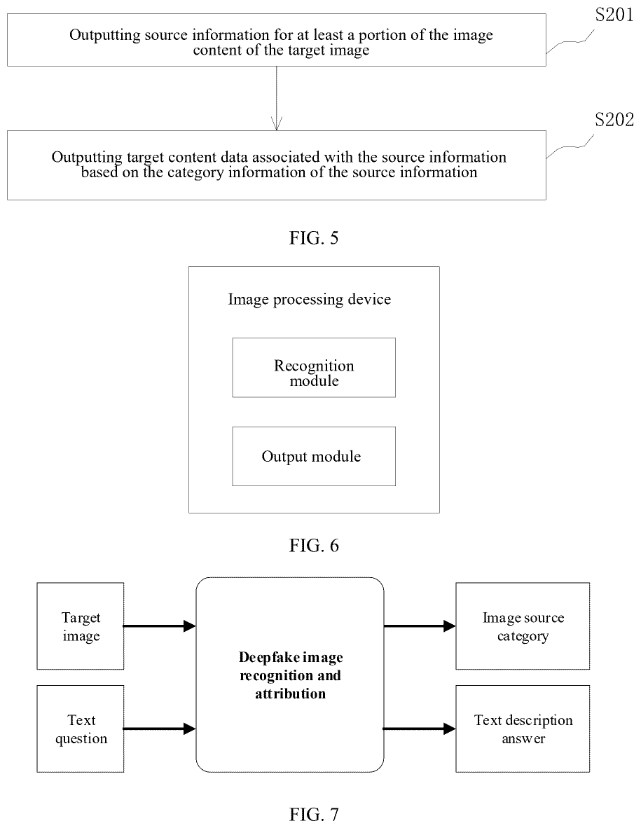

In certain embodiments, as shown in FIG. 5, outputting the recognition result for the target image includes:

S201. Outputting source information for at least a portion of the image content of the target image;

In certain embodiments, the system analyzes a target image, identifies, and outputs source information for at least part of the image's content. This source information includes image authenticity verification, source model, filming device, filming location (for example, a tourist attraction), camera position, and photographer.

S202: Outputting target content data associated with the source information based on the category information of the source information.

In certain embodiments, the source information category information determines whether to output an explanation or response associated with the source information, a recommendation for a tourist attraction, or a purchase or sharing link for a device.

Based on the identified source information, the system determines what type of information or link to output. The recognition result determines whether to output an explanation, and whether to output an explanation or associated response information.

In certain embodiments, the system determines whether to output an explanation based on the certainty of the recognition result or the user's needs. When the recognition result is clear and confident, or when the user explicitly requests an explanation, the system may provide an explanation. When an explanation is required, the system will determine whether to provide an explanation or associated response information. This decision depends on the nature of the recognition result and the user's particular needs.

In certain embodiments, when the recognition result is an image authenticity check or a source model, the user wants to understand the reasoning behind the recognition result, and an explanation is provided. When the recognition result is the shooting time, the user's question based on the image content is answered. When the recognition result is a tourist attraction or product, relevant recommendations are provided. When the recognition result involves purchasable goods or devices, a purchase link is provided. When the user may want to share the image, a sharing link is provided.

For example, a user uploads a photo taken in front of the Eiffel Tower in Paris and asks, “What is the background of this photo?”

After analyzing the image, the system determines that the background is the Eiffel Tower in Paris and outputs the source information for this portion of the image content: “The background of this image is the Eiffel Tower in Paris.”

The system identifies the source information as belonging to the “travel destination” category and therefore provides a “More Information” button as a secondary control. When the user clicks this button, the system displays additional data related to the Eiffel Tower in Paris: a purchase link providing links to purchase Eiffel Tower souvenirs; a travel destination configuration interface allowing the user to set Paris as a travel destination and displaying travel package information; and a sharing interface providing options for sharing the image on social media.

The present disclosure not only provides direct information about the image content but also offers related additional services and data based on the category of this information, enhancing the user experience and the practicality of the information.

In certain embodiments, as shown in FIGS. 7 and 8, the image processing method operates as follows:

The input data includes a target image X and a text question Q, and the output data includes an image category L and a text answer A.

The target image X undergoes image encoding to generate image feature data. This image feature data contains both global information about the target image and key regional information, supporting authenticity judgment for both the entire image and local regions. This image feature data is then processed by the classification module to generate the image category L as the first output data.

The text question Q is processed by the word embedding representation module, which segments the text sentence into a sequence of text characters and inserts characters such as separators into the text character sequence. Each character is then processed by the word embedding encoding module to generate a corresponding word embedding vector. The word embedding vectors of all characters are combined to form the text feature data for the text question.

The image and text feature data are processed through the image-text feature fusion module to generate fused features. This module associates the semantic information in the text question with the global and key regional information of the target image to support text questions about the target image as a whole and in its locale.

Finally, the autoregressive decoding module performs inference based on the fused feature data, generating a text statement corresponding to the image category judgment, and outputs a text answer A as the second output data.

In certain embodiments, as shown in FIG. 9, during image encoding, the target image X passes through the image encoding module to generate image features I. The target image X is evenly divided into nine image blocks, each of which corresponds to a position index number. All pixels in each image block are tiled and linearly projected to produce a corresponding image pixel sequence. The position index number of each image block undergoes position encoding to generate position encoding information. The image pixel sequence and position encoding information are concatenated to form an embedding image block containing position information.

To incorporate image category information into the image encoding process, a learnable category embedding is used to represent the image classification task. The category embedding is concatenated with index number 0 to produce an embedding image block representing the category information.

The embedding image block containing position information and the embedding image block representing category information are combined as an embedding image block. The embedding image block passes through the Transformer encoder to generate image features I.

The Transformer encoder includes M Transformer modules stacked in sequence. When M is 12, 24, or 32, the image encoding effect is optimal. The output data of the previous Transformer module serves as the input data of the next Transformer module.

In each Transformer module, the input data is first normalized by the layer, and then passes through the self-attention module. The generated data is added to the input data to generate the intermediate feature D. The intermediate feature D is then normalized by the layer and multi-layer perceptron, and then added to the intermediate feature D to generate the output data of the current Transformer module. The image feature I generated by the last Transformer module serves as the output of the Transformer encoder and also as the output of the image encoding module.

As shown in FIG. 10, when using a classification module, the input is image feature I and the output is the image category L. The classification module sequentially includes a multi-layer perceptron and a Softmax activation layer. The Softmax activation layer outputs a vector of probability values. The sum of all probability values is 1, and the category corresponding to the maximum probability value is considered the image category.

As shown in FIG. 11, when using word embedding representation, the input data of the word embedding representation module is a text question Q, and the output data is the word embedding S of the text. The word embedding representation module includes two steps: word tagging and word vector representation.

During the word tagging phase, the text question Q is segmented into a sequence of text characters based on semantic information. Tag separators are inserted at the beginning and end of the text question, as well as at semantic segmentation locations.

At the word vector representation phase, all text characters and tag separators in the text character sequence are represented as numerical word vectors. Each text character and tag separator corresponds to a word vector, and all word vectors are stacked to form the text's word embedding S.

As shown in FIG. 12, during word embedding encoding, the word embedding encoding module encodes the word embeddings S of a text into text features T. The word embedding encoding module includes N sequentially connected encoding layers, with the output data of each encoding layer becoming the input data of the next encoding layer.

In the i^{th} (1≤i≤N) encoding layer, the input data of this encoding layer passes through the self-attention module and is then added to the input data of this encoding layer to generate feature data Rⁱ1. Feature data Rⁱ1 undergoes layer normalization to generate feature data Rⁱ2.

After being processed through the multi-layer perceptron, feature data Rⁱ2 is added to feature data Rⁱ2 to generate feature data Rⁱ3. Feature data Rⁱ3 undergoes layer normalization to generate the output data of the i^{th} encoding layer. The output data of the last encoding layer serves as the output of the word embedding encoding module, namely, text feature T.

As shown in FIG. 13, when image-text feature fusion is performed, the input text feature T undergoes layer normalization and self-attention to generate feature T1. Feature T1 is added to text feature T to generate feature T2. Feature T2 undergoes layer normalization and is then fused with image feature I through cross-attention to generate feature G1.

Feature G1 is added to feature T2 to produce feature G2. Feature G2 then undergoes layer normalization and a multi-layer perceptron to produce feature G3. Finally, feature G3 is added to feature G2 to produce fused feature F, which serves as the output of the image-text feature fusion module.

As shown in FIG. 14, during autoregressive decoding, the input data of the autoregressive decoding module is fused feature F, and the output data is the text answer A. This module uses an autoregressive approach to predict and output text characters one by one. The process of predicting the next text character depends not only on the input fused feature but also on the text characters that have already been predicted and output.

When a new text character is output, the autoregressive decoding module updates the word embedding, generating a new text word embedding sequence W. This word embedding sequence W undergoes causal self-attention, a residual connection layer, and layer normalization to generate text feature E corresponding to the output text answer. The input fused feature F and text feature E undergo cross-attention to produce feature C1.

During the cross-attention process, the text features E are flattened to form the query vector, and the fused features F are flattened to form the key vectors and value vectors.

Feature C1 is added to text feature E to produce feature C2. Feature C2 undergoes layer normalization to produce feature C3. Feature C3 passes through a multi-layer perceptron and is then added to feature C3 to produce feature C4. Feature C4 undergoes layer normalization and a linear layer to produce a feature vector V. Feature vector V is predicted through a Softmax activation layer to produce a word embedding. The word embedding is generated through tag mapping to produce the current text character, which is placed at the end of the current text answer.

The resulting word embedding is then updated to produce a new word embedding sequence. This autoregressive process repeats until the text character generated by tag mapping is the terminator, resulting in the text answer A, which serves as the output of the autoregressive decoding module.

For example, in FIG. 18(a), the target image has a man's face in the foreground and a wall with a colorful pattern in the background. The user asks, “Is this image authentic?” After receiving the text question and the target image as input, the target image is analyzed and processed.

Then the image source is determined to be a “Stable Diffusion model,” indicating that the target image was generated by the Stable Diffusion model. A text answer is given, “This image is fake. The eyebrows on the face in the image appear unnatural and overlap. The face is generated by the Stable Diffusion model, but the background is authentic.” The present disclosure not only determines whether an image is fake in general, but also analyzes and determines the authenticity of local regions of the image.

In FIG. 18(b), the target image features a long-haired woman's face in the foreground and a gray background. The user asks, “Is the face in the photo authentic? Is the nose authentic?” The user's question focuses not only on the authenticity of the entire face but also on the authenticity of a certain region, namely the nose.

After analyzing and processing the target image, the system determines that the image's source is the “StyleGAN model,” indicating that it was generated by the StyleGAN model. It then provides the text answer, “The face in the photo is fake. The nose looks authentic, but the face lacks texture detail and the skin tone is too smooth.” This not only provides the global judgment, “The face in the photo is fake,” but also the regional judgment, “The nose looks authentic,” directly answering the user's question about the nose's authenticity.

In FIG. 18(c), the foreground of the target image is the face of a man in formal attire, and the background is partially blue and partially white. The user asks, “Is the face in the photo authentic?” After analyzing and processing the target image, the image source is determined to be an “authentic image,” indicating that the image was taken in the real world of physics. The text answer is given, “The face in the photo is authentic. This is a male face, and the overall face looks natural and coordinated.” This describes the authenticity of the male face in the image.

The present disclosure allows users to question the authenticity of an image using text. These questions may be asked not only about the entire image but also about certain regions, meeting user needs. This solution provides a technical foundation for the development of more intelligent multimodal (for example, user-generated voice) deepfake image recognition and attribution methods.

The present disclosure not only determines whether a target image is a deepfake, but also, if so, identifies the model used to generate it and locates the source of the deepfake. In practical implementations, this approach helps manage technical risks and ensure user safety.

The present disclosure uses text answers (other methods are also possible) to explain the authenticity of an image. It not only makes a global judgment on the authenticity of the image, but also analyzes and judges the authenticity of local regions of the image based on the user's question. This makes it easier for users to understand the logic behind the authenticity judgment and enhances the user experience.

Throughout the image processing process, three attention mechanisms are used: self-attention, causal self-attention, and cross-attention.

As shown in FIG. 15, the self-attention mechanism is used in both image and text encoding processes. There is only one input feature for self-attention, which may be either an image feature or a text feature. The input feature undergoes three different linear projection transformations to generate a query matrix, a key matrix, and a value matrix respectively. The query matrix is matrix-multiplied with the key matrix, scaled and activated by the Softmax layer, and then matrix-multiplied with the value matrix to generate the output feature.

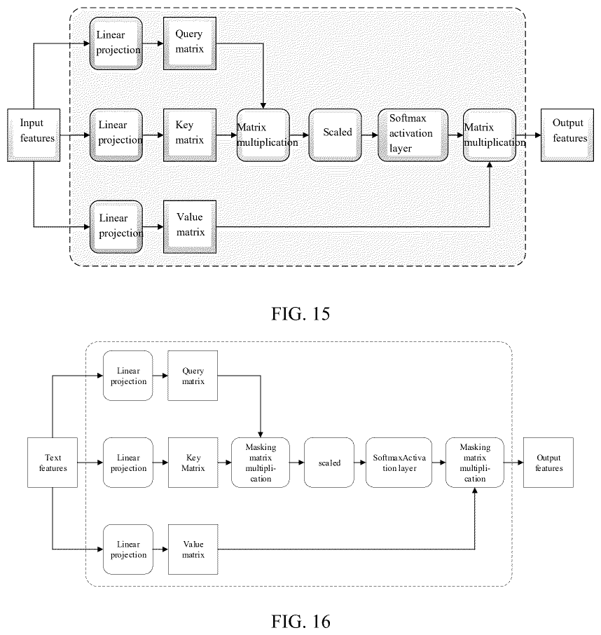

As shown in FIG. 16, the causal self-attention mechanism is used in the autoregressive decoding process. The input data is text features, and there is only one input. The input text features undergo three different linear projection transformations to generate the query matrix, key matrix, and value matrix respectively. Since the process of predicting the current text character only depends on the predicted text characters and the current text features, and does not depend on the text characters or text features predicted in the future. Therefore, the query matrix and the key matrix are multiplied by the masking matrix multiplication method, that is, the values corresponding to the future text features in the query matrix and the key matrix are masked and not allowed to participate in the matrix multiplication process. Only the values corresponding to the predicted text features are involved in the matrix operation process. The result of the masking matrix multiplication is scaled and passes the Softmax layer, and then multiplied with the value matrix through the masking matrix to generate the output features.

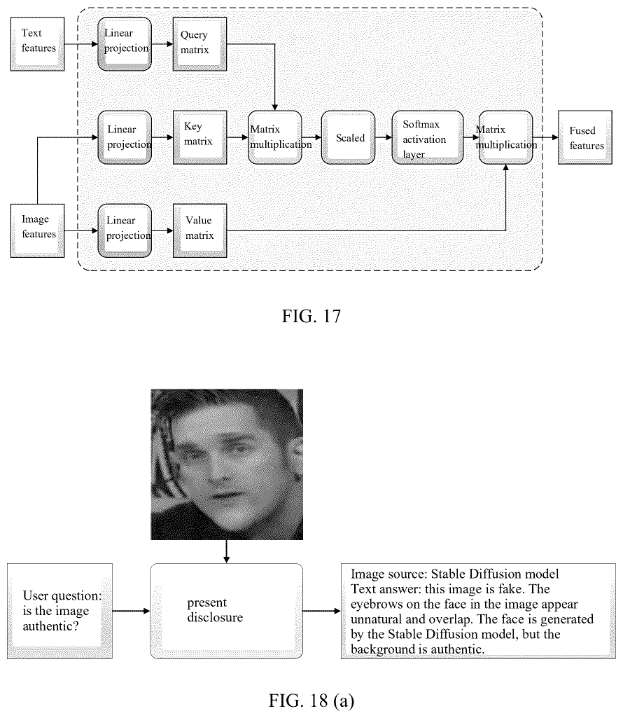

As shown in FIG. 17, the cross-attention mechanism is used in the image-text feature fusion module and the autoregressive decoding module. The fused features input to the autoregressive decoding module may be considered a particular type of image feature. The cross-attention mechanism takes two inputs: text features and image features. The text features are linearly projected to produce a query matrix, while the image features are linearly projected to produce a key matrix and a value matrix, respectively. The query matrix and the key matrix are matrix-multiplied. The result of this multiplication is scaled and activated by a Softmax layer before being matrix-multiplied with the value matrix to produce the fused features.

In certain embodiments, this solution requires constructing training samples and using them to train the network model before practical implementation.

When constructing training samples, mainstream image generation models are used to generate image samples, and these image samples are added to the training set. The category of each image is the image generation model used to generate the image. At the same time, the training set also contains an appropriate number of authentic images. The categories of these authentic images are labeled as “authentic images”. Several text questions about the authenticity of the image are provided for each image. Volunteers write text answers based on the text questions, focusing on the authenticity of the image globally and regionally. Each image, image category, text question and text answer are combined to form a sample of the training set.

In order to improve this solution and be able to identify various types of deep fake images in practical implementations, this solution collects a large number of multi-category and diverse training samples and uses various types of image generation models to generate fake images, including generative adversarial network (GAN) series methods and diffusion model series methods. The generative adversarial network series methods include AttGAN, CycleGAN, GDWCT, IMLE, ProGAN, StarGAN, StarGAN-v2, StyleGAN, StyleGAN2, or the like. The diffusion model series methods include DALL-E-2, GLIDE, Latent Diffusion, Stable Diffusion, or the like.

During the training phase, the network model is trained using training samples. To improve the model's robustness in implementations, data augmentation methods are used during the construction of the training set to simulate common operations in image applications, generating new sample images. These new sample images are then added to the training set to increase the diversity of the training samples. Data augmentation methods include adding Gaussian noise to the training sample images, performing Gaussian blurring, JPEG compression, rotation, and mirroring on the training sample images.

During the model training phase, the word embeddings generated by the autoregressive decoding module are compared with the word embeddings of the training samples using a loss function to calculate the loss. This loss is then used to update the model parameters through a backpropagation mechanism and an optimizer. This optimization process is only used for model training and is not required for actual inference.

The present disclosure also provides an image processing device, as shown in FIG. 6, including:

A recognition module, configured to, in response to a target trigger operation, perform recognition processing on a target image, where the target image is an image input to a target application or an image currently displayed by the target application, and the target application is an application capable of performing the recognition processing or calling a target program file to perform the recognition processing;

An output module, configured to output a recognition result for the target image, where the recognition result may at least indicate source information of at least a portion of the image content of the target image.

The principles for solving the technical problems of the image processing device provided in the embodiments of the present disclosure are similar to those of the image processing method provided in the embodiments of the present disclosure. Therefore, the implementation of the image processing device provided in the embodiments of the present disclosure may refer to the implementation of the image processing method provided in the embodiments of the present disclosure, and repeat description is avoided for brevity.

Certain embodiments of the present disclosure provide an electronic device including: a memory and a processor, wherein the memory stores an executable program, and the processor executes the executable program to implement the steps of any of the methods provided in the embodiments of the present disclosure.

The processor may be a general-purpose processor, a digital signal processor, an application-specific integrated circuit (ASIC), a programmable logic device (PLD), or any combination thereof. The PLD may be a complex programmable logic device (CPLD), a field-programmable gate array (FPGA), a generic array logic (GAL), or any combination thereof. The general-purpose processor may be a microprocessor or any conventional processor.

Since the electronic device described in the embodiments of the present disclosure is provided with a memory for implementing the methods disclosed in the embodiments of the present disclosure, the structure and variations of the electronic device described in the embodiments of the present disclosure may be based on the methods described in the embodiments of the present disclosure, and therefore, repeat description is avoided for brevity.

The embodiments of the present disclosure also provide a computer-readable storage medium having a computer program stored thereon. When executed by a processor, this computer program implements the steps of any of the image processing methods provided in the embodiments of the present disclosure.

The storage medium in certain embodiments may be included in the electronic device or may exist independently, not incorporated into the electronic device. The storage medium carries one or more computer programs. When executed, these one or more computer programs implement the steps of any of the task processing methods provided in the embodiments of the present disclosure.

Each solution in certain embodiments has the corresponding technical effects of the aforementioned method embodiments and repeat description is avoided for brevity.

According to certain embodiments of the present disclosure, the computer-readable storage medium may be a non-volatile computer-readable storage medium, and may include, but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination thereof. Alternatively, reference may be made to the examples described in any embodiment of the present disclosure, and repeat description is avoided for brevity. The modules or steps of the present disclosure described above may be implemented using a general-purpose computing device, they may be concentrated on a single computing device, or distributed on a network composed of multiple computing devices. Alternatively, they may be implemented using program code executable by the computing device, so that they may be stored in a storage device and executed by the computing device. In some cases, the steps shown or described may be performed in a different order than herein, or they may be made into separate integrated circuit modules, or multiple modules or steps may be made into a single integrated circuit module for implementation. Thus, the present disclosure is not limited to any particular combination of hardware and software.

The description reflects certain embodiments of the present disclosure and is not intended to limit the scope of the present disclosure. The scope of protection of the present disclosure is defined by the claims. Various modifications or equivalent substitutions to the present disclosure may be made within the essence and scope of protection of the present disclosure, and such modifications or equivalent substitutions are to fall within the scope of protection of the present disclosure.

What is claimed is:

1. An image processing method, comprising:
in response to a target trigger operation, performing recognition processing on a target image, wherein the target image is an image input to a target application or an image currently displayed by the target application, and the target application is an application capable of performing the recognition processing or calling a target program file to perform the recognition processing; and
outputting a recognition result for the target image, wherein the recognition result is capable of indicating source information of at least a portion of an image content of the target image.

2. The method of claim 1, wherein performing recognition processing on the target image includes one or more of:
in response to obtaining an operation by a target user inputting the target image into the target application, performing recognition processing on the target image;
in response to obtaining target question information for the target image displayed by the target application, performing recognition processing on the target image corresponding to the target question information;
in response to obtaining a selection operation for a question option displayed on the target application and directed to the target image, performing recognition processing on the target image corresponding to the selection operation;
in response to obtaining an operation by the target user to input the target image into a target application and target question information for the target image, performing recognition processing on the target image corresponding to the target question information; and
in response to detecting a change in usage information of an electronic device, performing recognition processing on the target image displayed by the target application.

3. The method of claim 1, wherein performing recognition processing on the target image includes:
obtaining image feature data of the target image, the image feature data including global and regional information of the target image; and
when target question information is not available, performing inference on the image feature data to obtain a recognition result for the target image; or
when target question information is available, obtaining text feature data of the target question information, fusing the image feature data and the text feature data to obtain fused feature data, and performing inference on the fused feature data to obtain the recognition result for the target image.

4. The method of claim 3, wherein obtaining the image feature data of the target image includes:
segmenting the target image into a plurality of image blocks and processing pixels of the image blocks into an image pixel sequence;
concatenating the image pixel sequence with position encoding information corresponding to each image block to obtain a first image block;
obtaining a second image block representing source information; and
encoding the first image block and the second image block using a first encoder to obtain the image feature data.

5. The method of claim 3, wherein performing inference on the image feature data to obtain the recognition result for the target image includes one or both of:
inputting the image features into a classification model including a multilayer perceptron and a first activation function to obtain source information of at least a portion of the image content of the target image; and
inputting the image features into the multilayer perceptron and an output layer including a second activation function to obtain source information of at least a portion of the image content of the target image and an explanation of the source information.

6. The method of claim 3, wherein extracting text feature data from the target question information includes:
segmenting the target question information into a text character sequence based on semantic information of the target question information, wherein tag separators are inserted into the text character sequence;
representing the text character sequence and the tag separators as word vector data; and
performing word embedding encoding on the word vector data to output the text feature data.

7. The method of claim 3, wherein performing inference on the fused feature data to obtain the recognition result for the target image includes:
decoding the fused feature data using an autoregressive decoding module to obtain response information to a question regarding at least a portion of the image content of the target image.

8. The method of claim 1, wherein outputting the recognition result for the target image includes one or more of:
outputting source information for at least a portion of the image content of the target image and an explanation of the source information;
outputting the source information for at least a portion of the image content of the target image and a first control, the first control being triggerable to display an explanation of the source information;
outputting source information for at least a portion of the image content of the target image and, when the source information is triggered, outputting an explanation of the source information;
outputting the source information for at least a portion of the image content of the target image and a first response to a first question about the at least portion of the image content; and
outputting the source information for at least a portion of the image content of the target image and a second control, the second control being triggerable to display information associated with the source information.

9. The method of claim 1, wherein outputting the recognition result for the target image includes:
outputting source information for at least a portion of the image content of the target image; and
outputting target content data associated with the source information based on category information of the source information.

10. An electronic device, comprising: a memory storing computer program instructions; and a processor coupled to the memory and configured to execute the computer program instructions and perform:
in response to a target trigger operation, performing recognition processing on a target image, wherein the target image is an image input to a target application or an image currently displayed by the target application, and the target application is an application capable of performing the recognition processing or calling a target program file to perform the recognition processing; and
outputting a recognition result for the target image, wherein the recognition result is capable of indicating source information of at least a portion of an image content of the target image.

11. The electronic device of claim 10, wherein performing recognition processing on the target image includes one or more of:
in response to obtaining an operation by a target user inputting the target image into the target application, performing recognition processing on the target image;
in response to obtaining target question information for the target image displayed by the target application, performing recognition processing on the target image corresponding to the target question information;
in response to obtaining a selection operation for a question option displayed on the target application and directed to the target image, performing recognition processing on the target image corresponding to the selection operation;
in response to obtaining an operation by the target user to input the target image into a target application and target question information for the target image, performing recognition processing on the target image corresponding to the target question information; and
in response to detecting a change in usage information of an electronic device, performing recognition processing on the target image displayed by the target application.

12. The electronic device of claim 10, wherein performing recognition processing on the target image includes:
obtaining image feature data of the target image, the image feature data including global and regional information of the target image; and
when target question information is not available, performing inference on the image feature data to obtain a recognition result for the target image; or
when target question information is available, obtaining text feature data of the target question information, fusing the image feature data and the text feature data to obtain fused feature data, and performing inference on the fused feature data to obtain the recognition result for the target image.

13. The electronic device of claim 12, wherein obtaining the image feature data of the target image includes:
segmenting the target image into a plurality of image blocks and processing pixels of the image blocks into an image pixel sequence;
concatenating the image pixel sequence with position encoding information corresponding to each image block to obtain a first image block;
obtaining a second image block representing source information; and
encoding the first image block and the second image block using a first encoder to obtain the image feature data.

14. The electronic device of claim 12, wherein performing inference on the image feature data to obtain the recognition result for the target image includes one or both of:
inputting the image features into a classification model including a multilayer perception and a first activation function to obtain source information of at least a portion of the image content of the target image; and
inputting the image features into the multilayer perceptron and an output layer including a second activation function to obtain source information of at least a portion of the image content of the target image and an explanation of the source information.

15. The electronic device of claim 12, wherein extracting text feature data from the target question information includes:
segmenting the target question information into a text character sequence based on semantic information of the target question information, wherein tag separators are inserted into the text character sequence;
representing the text character sequence and the tag separators as word vector data; and
performing word embedding encoding on the word vector data to output the text feature data.

16. The electronic device of claim 12, wherein performing inference on the fused feature data to obtain the recognition result for the target image includes:
decoding the fused feature data using an autoregressive decoding module to obtain response information to a question regarding at least a portion of the image content of the target image.

17. The electronic device of claim 10, wherein outputting the recognition result for the target image includes one or more of:
outputting source information for at least a portion of the image content of the target image and an explanation of the source information;
outputting the source information for at least a portion of the image content of the target image and a first control, the first control being triggerable to display an explanation of the source information;
outputting source information for at least a portion of the image content of the target image and, when the source information is triggered, outputting an explanation of the source information;
outputting the source information for at least a portion of the image content of the target image and a first response to a first question about the at least portion of the image content; and
outputting the source information for at least a portion of the image content of the target image and a second control, the second control being triggerable to display information associated with the source information.

18. The electronic device of claim 10, wherein outputting the recognition result for the target image includes:
outputting source information for at least a portion of the image content of the target image; and
outputting target content data associated with the source information based on category information of the source information.

19. An electronic device comprising computer readable storage medium storing computer program instructions, when executable by at least one or more processors, the computer program instructions implementing a processing model, the processing model being called upon by a target application to implement an image processing method comprising:
in response to a target trigger operation, performing recognition processing on a target image, wherein the target image is an image input to a target application or an image currently displayed by the target application, and the target application is an application capable of performing the recognition processing or calling a target program file to perform the recognition processing; and
outputting a recognition result for the target image, wherein the recognition result is capable of indicating source information of at least a portion of an image content of the target image.

20. The electronic device of claim 19, wherein performing recognition processing on the target image includes one or more of:
in response to obtaining an operation by a target user inputting the target image into the target application, performing recognition processing on the target image;
in response to obtaining target question information for the target image displayed by the target application, performing recognition processing on the target image corresponding to the target question information;
in response to obtaining a selection operation for a question option displayed on the target application and directed to the target image, performing recognition processing on the target image corresponding to the selection operation;
in response to obtaining an operation by the target user to input the target image into a target application and target question information for the target image, performing recognition processing on the target image corresponding to the target question information; and
in response to detecting a change in usage information of an electronic device, performing recognition processing on the target image displayed by the target application.
